(19) United States
(12) Patent Application Publication
(10) Pub. No.: US 2005/0137976 A1
(43) Pub. Date: Jun. 23, 2005

(54) Automated system for payment commitment for content prior to creation

(76) Inventors: Glen J. Anderson, Sioux City, IA (US); Russell F. McKnight, Sioux City, IA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/824,716

(22) Filed: Apr. 15, 2004

Related U.S. Application Data
(60) Provisional application No. 60/530,542, filed on Dec. 18, 2003.

(51) Int. Cl. G06F 17/60

(52) U.S. Cl. 705/40

(57) ABSTRACT

A method is described for determining interest in a work product capable of being distributed over the Internet. A work product sample is presented during a time period at a website. Votes are received from nodes connected to the network. The creation of a work product is initiated based on the result of the vote. A payment commitment is received from the node prior to initiating creation. Alternatively, payment for access from the node is received and access provided to the work product. The work product is delivered when creation is completed.

### CROSS-REFERENCE TO RELATED APPLICATIONS

The present invention is related to and claims priority under 35 U.S.C. § 119(e) from Provisional Application Ser. No. 60/530,542 filed Dec. 18, 2003.

### BACKGROUND OF THE INVENTION

1. Field of the Invention

The present invention relates to on-line transaction method, and more specifically to a method for gaining advance payment commitments for the creation of content.

2. Brief Description of the Related Art

The creation of high quality content including, for example, content having high levels of artistic merit, such as artwork, videos, works of literary authorship or the like, can be a risky and expensive undertaking both for the creator and for the sponsor, distributor, or other agency working with the creator to market and otherwise sell and distribute the created work. It can easily be imagined that hardships arise in connection with producing creative works with an uncertain audience and an equally uncertain commitment for payment should the work product be created. Although the Internet has made it easier for artists, authors, and other creators to make their work products available to the public, challenge still remain related to the creation of content. Committing resources to work product creation only to be unsure as to whether the content will find an available market often stifles creation in the first instance leading to the effective suppression of potentially enriching works.

From the consumer side, a common historical solution to the problem of having a specific work or type of work made according to a specific vision, desire, or agenda has been for individuals and organizations to commission creative agencies or individuals to create the desired products. Those wishing to have creative works produced on-demand simply specify to the artist what they desire to have made and, for an advance fee or similar arrangement, the artist or creator will make the desired product or work. In the case of the commissioned artist, the commitment to pay subject to completion of the work is sufficient incentive to motivate the artist to undertake the creative endeavor.

Problems arise with the classic commissioning model in that costs can be quite high for a particular work to be created. Among other factors, high costs can often be driven by the fact that a single party is often commissioning the creation of the work individually. The more specific and individually tailored the commissioning requirements, often the more expensive the commissioning fee for undertaking and completing the task. Further problems arise in that locating an artist capable of creating the work, monitoring progress dealing with delays and the like, make the conventional model ill suited for today's faster paced creative environment, an environment fueled by technological advancements such as the Internet.

Some systems exist for distributing and managing digital content and even prepaying for content not yet delivered. The system described in U.S. Pat. No. 6,434,535 B1 issued on Aug. 13, 2002 to Kupka et al., for example, allows a user to prepay for content using removable prepaid media on which content can be loaded. The electronic content however must be selected from protected electronic data offered for sale for a fee. Kupka et al. fails to address the need for user interaction so as to affect the creation process.

Pay per view systems exist which allow payments for access to content to be managed. The architecture described in U.S. Pat. No. 6,349,288 B1 issued on Feb. 19, 2002 to Barber for example, allows a highly distributed network of servers to provide payment for access, refunds, and the like. The focus in Barber however is on management of access and not creation of work. In U.S. Pat. No. 6,282,653 B1, issued on Aug. 28, 2001 to Berstis et al., a method for royalty collection is described where use of a digital file including content subject to copyright protection is managed by, for example, maintaining a copy count and destroying the file or preventing further copies when a given value is reached. None of these systems however addresses the need for interacting with users prior to the creation of content.

It would be helpful to have commitment from users to pay for the content prior to the creation of the content. An automated system could be created to accomplish this goal. Consequently, it would be desirable to provide a method for addressing the creation of work products with payment commitments already in place.

### SUMMARY OF THE INVENTION

Thus the present invention is directed to a method for determining a level of interest in a work product such as an art work, a musical work, a work of authorship or the like, capable of being distributed over a network such as the Internet. In accordance with one exemplary embodiment, a sample of a proposed version of the work product is presented during a time period such as during a promotional period or the like and in a location such as on a website where the work is capable of being accessed from the network by individuals desiring to view the work sample. A vote can be received from a node connected to the network where the vote is associated with the desire to purchase either the proposed version of the work product or to express a content preference with a presumption that if the content associated with the content preference is made available, a purchase would be forthcoming. Based on the result of the received vote, the creation of the work product can be initiated, a work associated with the content preference can be initiated or the vote will result in no work being created. To ensure that a ready market exists, a payment commitment can be received from the node associated with the vote prior to the initiating the creation. It will be appreciated by one of ordinary skill that the payment commitment can consist of receiving payment, for example at a website over a network connection or the like such as the Internet. The payment is received from the node in exchange for access, whereupon access to the work product or the work associated with the content preference is provided when payment has been received and the work product or the work associated with the content preference is delivered or otherwise downloaded. If a vote for a particular work product sample or samples is not received during, for example, a designated time period, a new sample of a proposed version of a new work product can be presented during a new time period. The new sample can be presented in the location, e.g. the website or the like, capable of being accessed from the network. If for some reason the work product or the work associated with the content preference is not available, the payment commitment can be released after a deadline has expired such as a creation deadline. A creation deadline is preferably established associated with the initiation of creation of the work product or the work associated with the content preference.

In accordance with other exemplary embodiments, a method for marketing one or more work products capable of being distributed over the Internet is provided. In the exemplary method, proposed versions of the work products may be received from authors over the Internet during a time period such as a sample solicitation time period in a location, such as a website capable of being accessed from the Internet. The proposed versions are then presented at the location and votes received from nodes connected to the location over the Internet. The votes are associated with the proposed versions of the work products or content preferences and may be counted or otherwise tallied. The authors may be notified that a threshold for initiating creation of the work products or content preferences has been reached based on the received votes. In addition to receiving votes, payment commitments are received from the nodes associated with the votes prior to notifying the authors to initiate creation sparing the author potentially fruitless efforts. Payment may be received from the nodes to provide access to the work products or works associated with the content preferences. The work products or the works associated with the content preferences, may be delivered when creation is completed, payment has been received and content granted. If votes are not received during a prescribed time period, the proposed versions of the work products from the authors may be removed.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a diagram illustrating an exemplary content server, exemplary content creators, and exemplary content consumers connected over a network;

FIG. 2 is a block diagram illustrating exemplary provisioning of work product samples and related exemplary selection in accordance with various exemplary embodiments;

FIG. 3 is a block diagram illustrating exemplary work product samples and a related exemplary reception of payment commitments in accordance with various exemplary embodiments;

FIG. 4 is a block diagram illustrating exemplary provisioning of notification to authors associated with reception of payment commitments in accordance with various exemplary embodiments;

FIG. 5 is a block diagram illustrating exemplary delivery of work products in accordance with various exemplary embodiments;

FIG. 6 is a block diagram illustrating exemplary reception of payment and delivery of work products in accordance with various exemplary embodiments; and

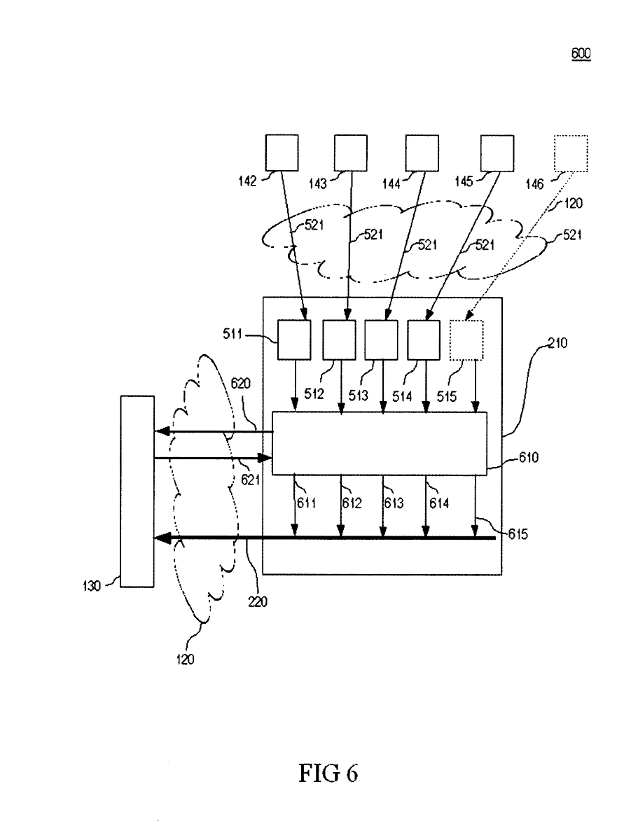

FIG. 7 is a flow diagram illustrating parts of an exemplary procedure in accordance with various exemplary embodiments.

### DETAILED DESCRIPTION OF THE INVENTION

The present invention in accordance with various exemplary embodiments, is directed to a method for providing a sample of a work product as a way of determining or otherwise gauging a level of interest in the work product. The work product may be an art work, a photographic work, a musical work, a work of authorship or the like, capable of being distributed over a network such as the Internet.

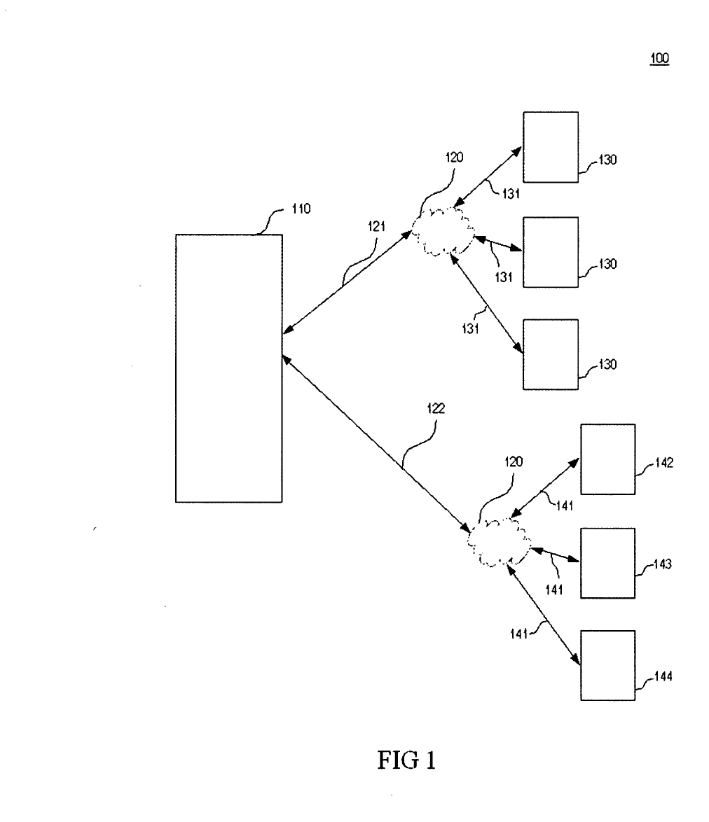

Reference will now be made in detail to the presently preferred embodiments of the invention, examples of which are illustrated in the accompanying drawings. In FIG. 1 of the drawings, an exemplary scenario 100 is shown wherein several potential consumers may connect, for example through consumer nodes 130, access connections 131, network 120, and a network connection 121 to a server 110. Network 120 may be an access network, a local area network, wide area network, or the Internet as would be appreciated by one of ordinary skill. Server 110 may be a host server connected to network 120 or may be an auxiliary server such as a content server or the like accessible from a host server such that content stored thereon can be made available to, for example, consumer nodes 130 and the like.

To provide content or at least, initially, samples of content, creator nodes 142 may be connected to server 110 through access connections 141, network 120, and network connection 122. It will be appreciated that network connections 121 and 122, 131, and 141 may be of sufficient speed, bandwidth, or the like to support, for example, streaming video or audio content. Access connections 131 and 141 may further be, for example, Digital Subscriber Lines (DSL) connections or the like while network connections 121 and 122 would preferably be relatively higher bandwidth connections such as T1, 100 MBps, or the like or would be connected to routers or other high capacity hardware to allow support for multiple high data transfer connections as would be appreciated by one of ordinary skill.

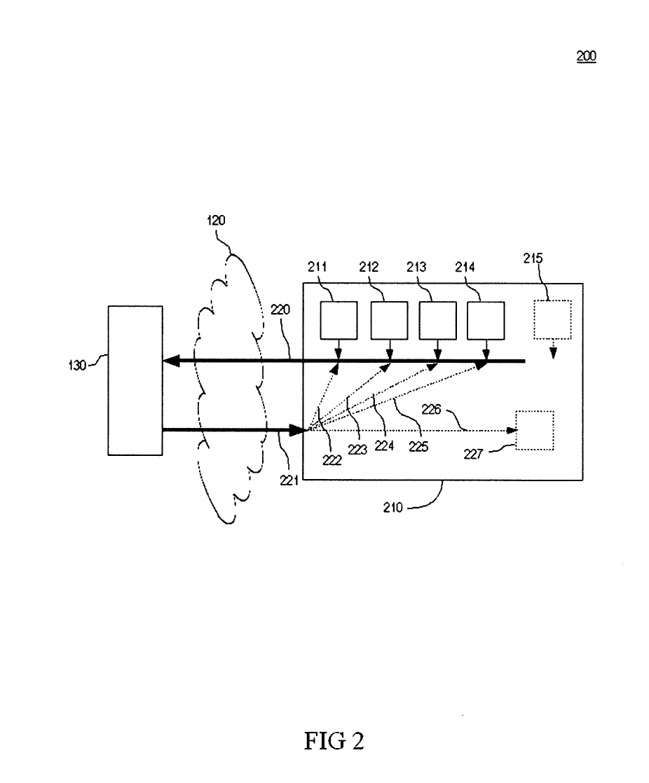

In exemplary scenario 200, illustrated in FIG. 2, consumer node 130 is shown connecting to server 210 through network 120 where samples 211-214 of digital content are being presented through connection 222. It will be appreciated that such presentation may be in the form of a website having a hypertext link or the like for each of samples 211-214, interaction with which link, over for example connection 221-224, may lead to more information such as sample expiration date, author biography, votes received to date, or like information which may be helpful in guiding consumer node 130 in making content selections. Consumer node 130 using connections 221-224 may further vote or otherwise make payment commitments as will be described in greater detail hereinafter, for the creation of content related to samples 211-214. Consumer node 130 could also be provided the opportunity to vote for an author or artist to return with new work at which point node 130 is charged for access. It will be appreciated that several node 130s allow spreading of costs making the per user cost low. Server 210 which may belong to an Internet Service Provier, web site publisher, or the like, could gauge the market for new content prior to its creation allowing more accurate negotiation for payment of content between publisher and creator where market forces could set the price paid for new content and in accordance with various exemplary embodiments, market forces can be more accurately determined. Thus, even in the case of an artist with a strong following, the method in accordance with the present invention would allow, for example, a sudden change in public sentiment regarding the work of the author to be immediately reflected in a waning interest in new material.

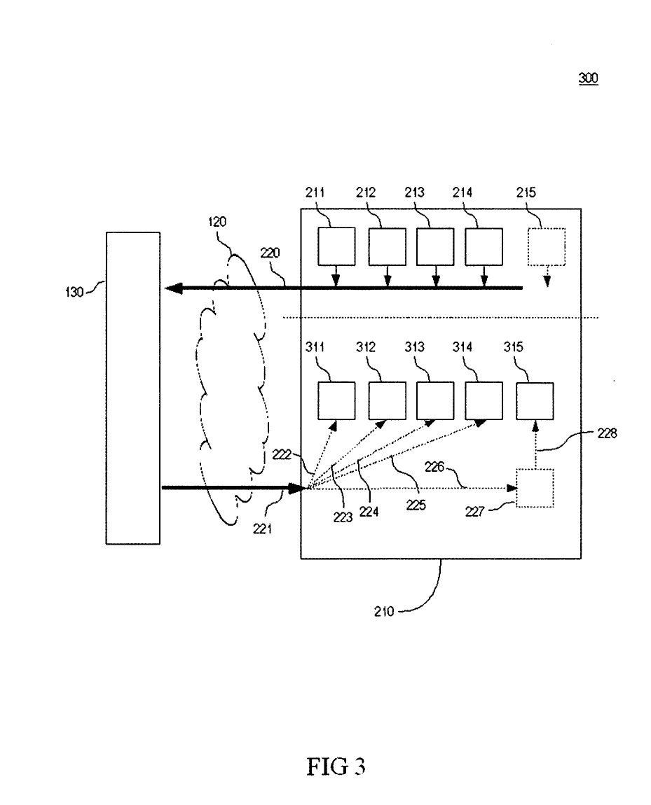

It should be noted that in addition to viewing samples 211-214, consumer node 130 may also suggest original content creation by making content suggestion 226 using connection 225 which may be a link to a text box, or other manner as would be appreciated by one of ordinary skill in the art, to provide for spontaneous input and related vote or payment commitment from consumer node 130. The sponsor of server 110 may preferably provide user suggestions such as user submitted suggestion 215 based on, for example, content suggestion 226. Further illustrated in FIG. 3 is exemplary scenario 300 where collection of votes, payments, or payment commitments by server 210 from consumer node 130 is performed. In accordance with some exemplary embodiments consumer node 130 could pre-pay, and, if content was not delivered on time, server 210 could be configured to reimburse accounts. Alternately, consumer node 130 might prepay a given amount and have incremental amounts deducted for each viewing of content, or consumer node 130 might be allowed to view some free content to raise interest.

Based on interest in samples 211-214, consumer node 130 may vote, submit advance payment for, or submit a payment commitment for samples of interest in boxes 311-314 through connections 221-224. It will be appreciated that votes, payment collection, or payment commitment collection may be available as other information presented through links or the like as described above. Also, through connection 225, interest and even payment commitments or the like may be accepted for suggested content 226.

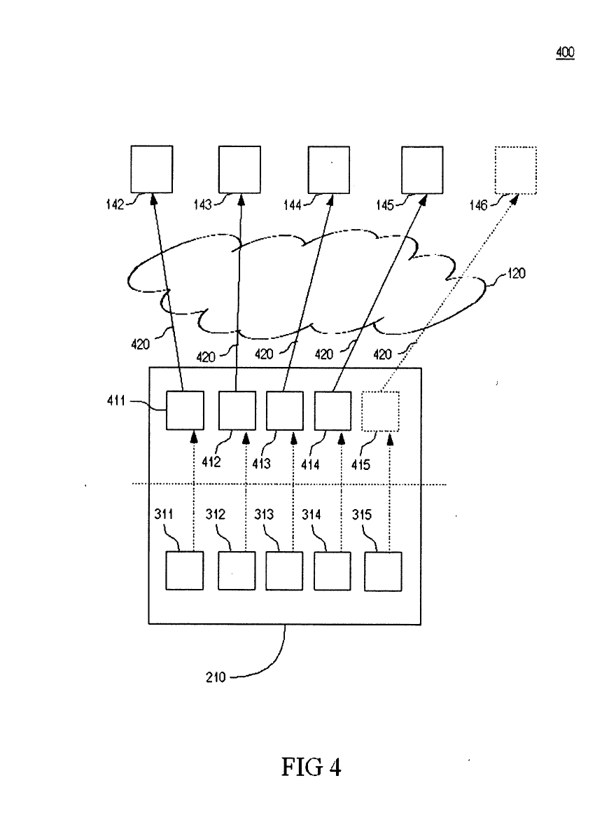

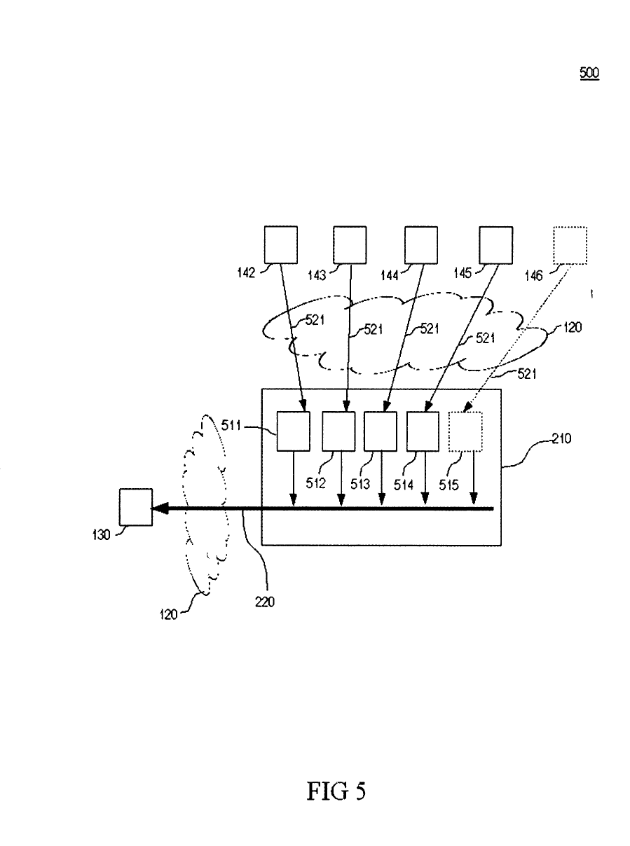

Once the interval for presentation of, for example, samples 211-214, expires, votes, payments, or payment commitments are tallied and processed and if certain criteria are met, such as a minimum number of votes, payments, or payment commitments, initiation of creation of work product may be issued as shown in FIG. 4 in exemplary scenario 400. Server 210 may process votes, payments, or payment commitments, from boxes 311-315 to form content creation processes 411-415. It will be appreciated that content creation processes 411-415 may send notification to respective creators 142-146 which can be multiple artists, creators, authors, or the like or may be a single entity such as a prolific artist, or a representative entity such as a recording label or the like. Accordingly, as shown in exemplary scenario 500 of FIG. 5, creators 142-146 may complete creative works and submit them to server 210 through network 120 such that completed works 511-515 can be presented to consumer node 130, again through network 120. It will be appreciated that completed works 511-515 can be presented in a separate area or can be presented in the same area where samples 211-215 were originally presented. Once completed works 511-515 are available, delivery or pick up can proceed.

In accordance with various exemplary embodiments, creators 142-146 submit proposals for content, for example, in a particular format, and consumer node 130 votes, prepays, submits a payment commitment or the like. Creators 142-146 are preferably informed automatically when, for example, a threshold demand is met and may be paid, preferably in part, at such a point. Creators 142-146 upon completion of the work, then post the content and are paid the balance. Alternatively, creators 142-146 could be paid per viewing by regular customers.

It will be appreciated that payment in the manner described above can be used in connection with existing payment systems or alternative payment systems. For example, an online magazine subscription or service could arrange for a portion of subscription fees to be allotted to the subscriber for pre-purchasing yet-to-be-created content. A consumer could distribute monthly subscription fees to certain proposed projects, e.g., $2 for a proposed video, $0.50 for a proposed article, or the like. If the proposed project failed to be created, the consumer would be allowed to redistribute the money, or it could be added to their account for future choices.

In exemplary scenario 600, provision for collecting payment and providing delivery of completed works 511-515 is shown. Collection process 610 may handle, for example, notification to consumer node 130 that completed works are available based on either a payment commitment or a vote. Payments may be received and processed by collection process 610 and if successfully processed, content may be delivered on delivery channels 611-615. Optionally, collection process 610 may be configured to simply notify consumer node 130 that the completed work is available for pick-up if, for example, the work was previously paid for. In addition, collection process 610 may handle scenarios where the work is not completed in time and consumer node 130 may either be notified that the work is, as yet, unavailable providing the option to continue waiting, or, in the event consumer node 130 does not wish to wait, or to cancel the payment commitment. If the work was previously paid for, collection process 610 may credit the account of consumer node 130.

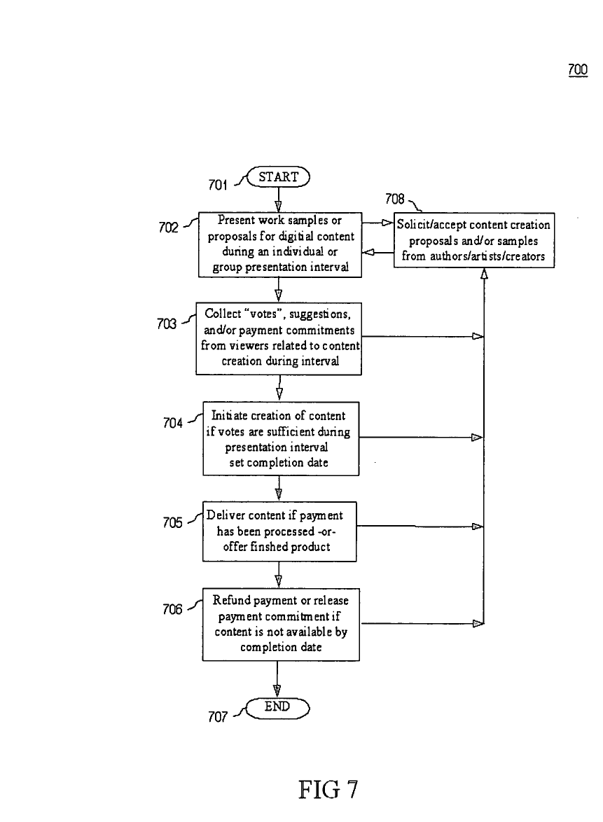

Exemplary procedure 700 is shown in FIG. 7 wherein various stages and steps associated with carrying out various exemplary embodiments of the claimed invention are shown. After start at 701, work samples may be presented for voting or otherwise accepting payments, or payment commitments at 702 during a presentation time interval, e.g. a time after which votes for the content may not be accepted and after which, if a minimum number of votes are not received, the content will be withdrawn or replaced. At 703 votes for content may be collected. Alternatively, suggestions or proposals for content may be accepted. It will be appreciated that for content suggestions or proposals, a minimum commitment may be required since the suggestion or proposal will deviate from the collective offerings already being presented and will help to defray costs associated with presenting the suggestions to the greater consumer community. If votes, payments, or payment commitments are sufficient during the presentation interval, creation of content associated with the presented samples may be initiated at 704 and creators paid preferably a portion of the agreed upon fee with the remainder due upon completion. It will also be appreciated that different arrangements may be made to best incentivize artists to complete the highest quality work product in the most rapid manner such as a portion of proceeds from ongoing sales and the like.

During initiation of creation, a completion date may be established such that consumer notification can be made and refunds and the like processed if work is not completed on time. It can be appreciated that artists, authors, creators, or the like who consistently fail to deliver content on time may be restricted from making offerings in the future or may alternatively be rated in terms of delivery performance so that consumers can decide if the desired content from the particular artist, author, or creator is worth waiting for.

Once content is created, it can be delivered if already paid for, or can be offered for deliver or pick-up if a vote or a payment commitment was received at 705. As noted above, content may be made available, for example, in the same location on the web page where samples were presented, and a notification sent to consumer nodes who either voted or registered a payment commitment. If the content is not available by the due date, a notification can be sent out to each consumer inquiring whether the consumer wishes to wait for the content. A release from a payment commitment may be made or a refund may be offered for consumers who have already paid for consumers who do not wish to continue waiting for the content.

It is believed that the method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A method for determining a level of interest in a work product capable of being distributed over a network comprising:
presenting a sample of a proposed version of the work product during a time period in a location capable of being accessed from the network;
receiving a vote from a node connected to the network, the vote associated with one of the proposed version of the work product and a content preference; and
initiating the creation of one of: the work product, a work associated with the content preference, and no creation, based on the result of the vote.

2. The method according to claim 1, further comprising receiving a payment commitment from the node associated with the vote prior to the initiating the creation.

3. The method according to claim 1, further comprising:
receiving payment for access from the node; and
providing the access to the one or more of the work product and the work associated with the content preference when payment has been received.

4. The method according to claim 1, wherein the location includes a website.

5. The method according to claim 3, wherein the receiving payment includes receiving payment over the network.

6. The method according to claim 5, wherein:
the network includes the Internet,
the location includes a website connected to the Internet, and
the receiving payment includes receiving payment from the node over the Internet at the website.

7. The method according to claim 2, further comprising delivering the one of the work product and the work associated with the content preference, when creation is completed.

8. The method according to claim 1, further comprising presenting a new sample of a proposed version of a new work product during a new time period in the location capable of being accessed from the network if the vote is not received from the node during the time period.

9. The method according to claim 2, further comprising releasing the payment commitment after a deadline has expired if one of the work product and a work associated with the content preference is unavailable.

10. The method according to claim 1, further comprising establishing a creation deadline associated with the initiation of creation of the one of the work product and a work associated with the content preference.

11. A method for marketing one or more work products capable of being distributed over the Internet comprising:
receiving one or more at least proposed versions of the one or more work products from one or more authors over the Internet during a time period in a location capable of being accessed from the Internet;
presenting the received one or more at least proposed versions at the location;
receiving one or more votes from one or more nodes connected to the location over the Internet, the one or more votes associated with one or more of the one or more at least proposed version of the one or more work products and one or more content preferences; and
notifying one or more of the one or more authors that a threshold for initiating the creation of one or more of the one or more work products or one or more content preferences has been reached based on the received one or more votes.

12. The method according to claim 11, further comprising receiving one or more payment commitments from the one or more nodes associated with the vote prior to the notifying for the initiating the creation.

13. The method according to claim 11, further comprising:
receiving payment for access from the one or more nodes; and
providing the access to the one or more of the one or morework products and one or more works associated with the one or more content preferences when payment has been received.

14. The method according to claim 12, further comprising delivering the one or more of the one or more work product and the one or more works associated with the one or more content preferences, when creation is completed.

15. The method according to claim 11, further comprising removing the one or more at least proposed versions of the one or more work products from one or more authors if the one or more votes are not received during the time period.
